(19) United States
(12) Patent Application Publication
(10) Pub. No.: US 2025/0358111 A1
(43) Pub. Date: Nov. 20, 2025

(54) Forming a Cryptographically Protected Connection

(71) Applicant: Siemens Aktiengesellschaft, München (DE)

(72) Inventor: Rainer Falk, Erding (DE)

(73) Assignee: Siemens Aktiengesellschaft, München (DE)

(21) Appl. No.: 18/854,786

(22) PCT Filed: Mar. 14, 2023
(86) PCT No.: PCT/EP2023/056453

§ 371 Date: Oct. 7, 2024

(30) Foreign Application Priority Data
Apr. 6, 2022 (EP) 22166951.8

(51) Int. Cl. H04L 9/32

(52) U.S. Cl. CPC H04L 9/32

(57) ABSTRACT

Various embodiments of the teachings herein include a method for forming a first cryptographically protected connection of a device to a unit. An example includes: transmitting a connection request from the device, wherein the connection request includes associated cryptographically protected device connection information and device authentication information, wherein the device connection information indicates a second connection of the device to a second device existed at an earlier time, wherein the device authentication information authenticates the device; checking the first device connection information and a second device connection information for a first match; checking the device connection information and the device authentication information for a second match; and forming the first cryptographically protected connection of the device to the unit based on the first match and the second match.

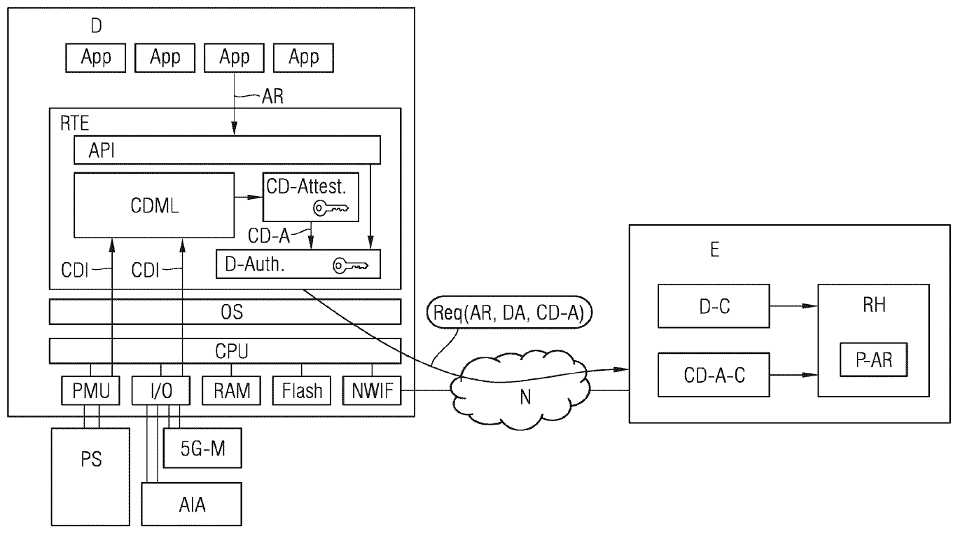

### CROSS-REFERENCE TO RELATED APPLICATIONS

This application is a U.S. National Stage Application of International Application No. PCT/EP2023/056453 filed Mar. 14, 2023, which designates the United States of America, and claims priority to EP Application Serial No. 22166951.8 filed Apr. 6, 2022, the contents of which are hereby incorporated by reference in their entirety.

### TECHNICAL FIELD

The present disclosure relates to network connections. Various embodiments of the teachings herein include methods and/or systems for forming a cryptographically protected connection of a device to a unit

### BACKGROUND

The simple, initial setup of a security configuration on a device, in particular an industrial IoT device or a mobile radio device, is a basic objective. This is also referred to as provisioning, onboarding, bootstrapping or pairing. There are contradictory requirements here: on the one hand, this should take place in a manner that is as automated as possible and require no or only a minimal amount of user interaction in the process, but, on the other hand, it should be possible to closely monitor which devices are accepted as admissible devices in a critical environment, in particular an industrial environment. The solution should also be able to be used flexibly in different deployment scenarios without being reliant on a specific and centralistic security infrastructure, in particular of a mobile radio provider or a group of mobile radio providers or a specific PKI infrastructure.

Previous initial setup solutions protect the setup process per se, such that only admissible setup takes place. However, these solutions require complex manual or administrative interactions, in particular in order, in each setup process, to separately input or load admissibility information that is strong enough from a security viewpoint, such as a password or an onboarding token, or they require a security infrastructure that provides the corresponding security information. In this case too, however, the corresponding information has to be set up. In this case too, online connectivity to public networks (the Internet) may be necessary. Such solutions are therefore laborious and can sometimes be used only to a limited extent in typical industrial application scenarios (industrial IoT).

A technical implementation for automated admissibility checks is challenging especially in the initial setup of a security configuration, since no or only a minimal security configuration is available here as a basis for the admissibility check. However, admissibility checks when accessing a device are also relevant in a wide variety of other application scenarios, such as when accessing a cloud service, an edge server, another IoT device, or when accessing a communication network, in particular WLAN, 5G and/or Ethernet.

### SUMMARY

The teachings of the present disclosure include methods and/or systems providing an improved admissibility check for a device, in particular in connection with the setup of a security configuration on a device. Generally speaking, there is a need for an improved option for checking the admissibility of an access operation. For example, some embodiments of the teachings herein include a method for forming a first cryptographically protected connection of a device (D) to a unit (E), comprising: the device (D) transmitting a connection request (Req), wherein cryptographically protected device connection information (CD-A) and device authentication information (DA) is associated with the connection request (Req), wherein the device connection information (CD-A) indicates which at least one second connection of the device (D) to at least one second device existed at an earlier time, wherein the device authentication information (DA) authenticates the device (D), and forming the first cryptographically protected connection of the device (D) to the unit (E) on the basis of a result of a check (P-AR) on the device connection information (CD-A) and the device authentication information (DA), wherein the cryptographically protected connection of the device (D) to the unit (E) is also formed on the basis of second device connection information, wherein the first device connection information (CD-A) and the second device connection information is checked for a match.

In some embodiments, the device connection information (CD-A) additionally indicates at least one second device with which the at least one connection currently exists.

In some embodiments, the device connection information (CD-A) includes: an identifier, in particular with regard to a device manufacturer, device type and/or device serial number, and/or an authentication credential, in particular a certificate, a cryptographic key and/or a password hash of the at least one second device with which the at least one second connection existed.

In some embodiments, additional information is additionally associated with the connection request (req), this additional information indicating in particular: the time at which and/or the duration for which and/or the device interface via which and/or at least one third connection in combination with which the at least one second connection existed.

In some embodiments, the device connection information (CD-A) is provided by: the device (D) and/or an external unit.

In some embodiments, the second device is designed as: a peripheral device and/or an expansion module and/or a tool of a machine tool and/or an IoT device and/or a second device connected mechanically to the device (D).

In some embodiments, the unit (E) is designed as: a server (E) and/or a cloud service (E) and/or an edge device (E) and/or a controller (E) and/or a control function (E) and/or a third device (E), in particular a second IoT device (E) and/or a communication network (E) and/or an onboarding network (E) and/or a provisioning server (E) and/or a device management server (E).

In some embodiments, rules are used to check (P-AR) the connection request (req), based on which a decision is made: to give permission or to give limited permission to form the first cryptographically protected connection of the device (D) to the unit (E).

In some embodiments, the connection request (req) is transmitted to the unit (E) and/or the device connection information (CD-A) and/or the device authentication information (DA) is checked (P-AR) by the unit (E).

In some embodiments, the device authentication information (DA) is designed as a device fingerprint of the device (D).

In some embodiments, the device authentication information (DA) is cryptographically protected, in particular by a cryptographic signature.

In some embodiments, there is a transmission unit designed to transmit the connection request (req), wherein the cryptographically protected device connection information (CD-A) and the device authentication information (DA) is associated with the connection request (req), wherein the device connection information (CD-A) indicates the at least one second connection of the device (D) to the at least one second device that existed at an earlier time, wherein the device authentication information (DA) authenticates the device (D), and a connection unit designed to form the first cryptographically protected connection of the device (D) to the unit (E) on the basis of the result of the check (P-AR) on the device connection information (CD-A) and the device authentication information (DA), wherein the cryptographically protected connection of the device (D) to the unit (E) is furthermore formed on the basis of second device connection information, wherein the first device connection information (CD-A) and the second device connection information is checked for a match.

As another example, some embodiments include a method for forming a first cryptographically protected connection of a unit (E) to a device (D), comprising: receiving a connection request (req) from the device (D), wherein cryptographically protected device connection information (CD-A) and device authentication information (DA) is associated with the connection request (req), wherein the device connection information (CD-A) indicates which at least one second connection of the device (D) to at least one second device existed at an earlier time, wherein the device authentication information (DA) authenticates the device (D), and forming the first cryptographically protected connection of the unit (E) to the device (D) on the basis of a result of a check (P-AR) on the device connection information (CD-A) and the device authentication information (DA), wherein the cryptographically protected connection of the device (D) to the unit (E) is furthermore formed on the basis of second device connection information, wherein the first device connection information (CD-A) and the second device connection information is checked for a match.

As another example, some embodiments include a unit (E) for carrying out one or more of the methods described herein, comprising: a reception unit designed to receive a connection request (req) from the device (D), wherein the cryptographically protected device connection information (CD-A) and the device authentication information (DA) is associated with the connection request (req), wherein the device connection information (CD-A) indicates the at least one second connection of the device (D) to the at least one second device that existed at an earlier time, wherein the device authentication information (DA) authenticates the device (D), and a connection unit designed to form the first cryptographically protected connection of the unit (E) to the device on the basis of the result of the check (P-AR) on the device connection information (CD-A) and the device authentication information (DA), wherein the cryptographically protected connection of the device (D) to the unit (E) is furthermore formed on the basis of second device connection information, wherein the first device connection information (CD-A) and the second device connection information is checked for a match.

### BRIEF DESCRIPTION OF THE DRAWINGS

The particular features and advantages of the teachings herein are apparent from the following explanations of a plurality of exemplary embodiments with reference to the schematic drawing, in which:

The FIGURE shows a schematic illustration of a device and a unit for carrying out one or more of the methods incorporating teachings of the present disclosure.

### DETAILED DESCRIPTION

The present disclosure describes systems and/or methods for forming a first cryptographically protected connection of a device to a unit. From the point of view of the device to be connected, the method comprises:
the device transmitting a connection request, wherein cryptographically protected device connection information and device authentication information is associated with the connection request,
wherein the device connection information indicates which at least one second connection of the device to at least one second device existed at an earlier time, wherein the device authentication information authenticates the device, and
forming the first cryptographically protected connection of the device to the unit on the basis of a result of a check on the device connection information and the device authentication information.

Confirming information, indicates other, second devices to which the device to be connected was connected in the past, in cryptographically protected form. During an access operation of the device, in particular for accessing a unit such as a cloud service, an edge device, a controller, a further IoT device, a communication network, when accessing an onboarding network, a provisioning server or a device management server, the device connection information in relation to the previously connected second devices is provided in tamperproof form. Authorization information that permits a certain access operation for this device, in particular for accessing a unit such as a provisioning server in order to perform a provisioning process, does not have to be set up explicitly for a specific device. Instead, this information may be inferred indirectly.

If, in the course of the defined process, a device to be put into operation is connected to other, that is to say second, devices, also possibly referred to as components, in accordance with the defined procedure, this implicitly gives the authorization to permit specific logic access operations in particular for automatic provisioning of security credentials on the device by a provisioning server.

In some embodiments, the device connection information additionally indicates at least one second device with which the at least one connection to the device to be connected currently still exists. The respective second connection may thus be disconnected again at the confirmation time or may continue to exist.

In some embodiments, the device connection information includes:
an identifier, in particular with regard to a device manufacturer, device type and/or device serial number, and/or
an authentication credential, in particular a certificate, a cryptographic key and/or a password hash
of the at least one second device with which the at least one second connection existed. The device to be connected determines the device connection information, in particular when the second connection exists, and stores said information itself or forwards it to an external memory for storage.

In some embodiments, additional information is additionally associated with the connection request, this additional information indicating in particular:
the time at which and/or
the duration for which and/or
the device interface via which and/or
at least one third connection in combination with which the at least one second connection existed.

The additional information may be stored locally by the device itself, in particular in a flash memory or in a security element of the device. In some embodiments, the information may also be stored by the device in an external memory, in particular in an interchangeable storage module, such as an SD card, a database, a distributed database (for example distributed ledger, blockchain), e.g. in the form of a cryptographically protected transaction data structure. Information stored in an external memory preferably also comprises identification information regarding the device, for example an identifier or an authentication credential of the device.

In some embodiments, the device connection information is provided by:
the device and/or
an external unit.

The device connection information may be provided by the device itself, which provides this information together with an access operation or associated with an access operation. In some embodiments, device connection information may be provided by a connected device, by a separate unit, in particular a web service, or by a distributed database.

In some embodiments, the cryptographically protected connection of the device to the unit is also formed on the basis of second device connection information, wherein the first device connection information and the second device connection information is checked for a match. This may be advantageous when the device connection information is provided by the device and an external unit. In this variant, multiple items of device connection information provided by different authorities are checked for a match. This makes it possible to consider a previous second connection as correct only when it is confirmed not just by the device itself, but rather additionally also by the respective previously connected second device or when it is additionally confirmed by a distributed database. This may allow a higher security level to be achieved.

In some embodiments, the second device is designed as:
a peripheral device and/or
an expansion module and/or
a tool of a machine tool and/or
an IoT device and/or
a second device connected mechanically to the device and preferably not able to be removed without being destroyed.

Some connected second devices may thus also be fixedly connected to the accessing device, in particular fixedly installed therein, in particular in an internal expansion slot or plug-in location, or else possibly also adhesively bonded, cast or soldered.

In some embodiments, the unit is designed as:
a server and/or
a cloud service and/or
an edge device and/or
a controller and/or
a control function and/or
a further, third device, in particular a second IoT device and/or
a communication network and/or
an onboarding network and/or
a provisioning server and/or
a device management server.

The access operation originating from the device, and thus the first cryptographically protected connection, may concern in particular one of the following cases:
network access authentication (WLAN, 5G mobile radio, IEEE 802.1X)
authentication with respect to the provisioning server, device management server
authentication with respect to the control computer/control function (virtualized control computer, for example on an industrial edge device)
authentication with respect to another device, edge device, backend cloud

In some embodiments, rules are used to check the connection request, based on which a decision is made:
to give permission or
to give limited permission
to form the first cryptographically protected connection of the device to the unit. Depending on the other, second devices to which the accessing device in question was connected in the past, the access operation is permitted, modified, that is to say given limited permission, or rejected.

The formation of the first cryptographically protected connection and thus the access operation may in particular be permitted when the accessing device was connected to a specific other device in a specifiable previous time window. Generally speaking, in order to determine the admissibility of an access operation, it is possible to evaluate other, second devices to which the accessing device was connected and when, for how long, at what location and in what order.

This means that it is not necessary to set up authorization information explicitly for a specific device that permits a specific access operation by a unit, in particular for accessing a provisioning server for performing a provisioning process. Instead, this information may be inferred indirectly. For this purpose, it is necessary just to define rules that correspond to the usual admissible procedures for commissioning a device in a specific application environment.

The previous connection of the device to one or more second devices via the second connection may in particular have been carried out in the following ways:
plugging on peripheral devices via a local interface, for example USB, SPI, RS232, SD card interface
establishing a transfer of power using a power supply unit (in particular USB power delivery or a wireless/inductive power supply, such as for example a wireless Qi charging interface)
plugging on expansion modules (for example plugged-on expansion modules, connected via a backplane bus, of an industrial component such as for example a programmable logic controller PLC). The expansion modules may be in particular a communication module (for example a 5G communication module)
plugging on or mounting a tool in the case of a machine tool (for example milling head, drill bit)
connections to a network (connection to a mobile radio network, for example a public mobile radio network, a 5G campus network, a 5G network slice, a specific WLAN network with network access authentication, a specific enterprise network with IEEE 802.1X network access control
cryptographically protected authenticated connection to servers, cloud services, other devices via a communication network (the Internet, enterprise network, factory network, campus network).

In some embodiments,
the connection request is transmitted to the unit and/or
the device connection information and/or the device authentication information is checked by the unit.

In some embodiments, the steps may be performed by a further unit, such as a further server.

In some embodiments, the device authentication information is designed as a device fingerprint of the second device. The second device with which the second connection is intended to be set up may authenticate itself cryptographically with respect to the first device, as known for example from USB 3.0 or PCIe.

It is also possible to identify the second device on the basis of a device fingerprint, that is to say on the basis of an indirect device-specific property, in particular a similar property of the device interface that depends on physical properties of electronic interface modules used or that results from manufacturing tolerances, in particular deviations of resistances, capacitances, inductances from their nominal value. A frequency dependence may be considered here.

The device that sets up the first connection to the unit is preferably able to authenticate itself cryptographically, as known for example from TLS, DTLS, IPsec/IKEv2, MACsec or OPC UA.

In some embodiments, the device authentication information is cryptographically protected, in particular by a cryptographic signature. In some embodiments, it may also be protected by a symmetric cryptographic checksum, that is to say a message authentication code (MAC), or may be designed as a verifiable credential or verifiable presentation.

Some embodiments include a device for carrying out one or more of the methods as described herein, comprising:
a transmission unit designed to transmit the connection request, wherein the cryptographically protected device connection information and the device authentication information is associated with the connection request,
wherein the device connection information indicates the at least one second connection of the device to the at least one second device that existed at an earlier time,
wherein the device authentication information authenticates the device, and
a connection unit designed to form the first cryptographically protected connection of the device to the unit on the basis of the result of the check on the device connection information and the device authentication information,
wherein the cryptographically protected connection of the device to the unit is furthermore formed in particular on the basis of second device connection information,
wherein the first device connection information and the second device connection information is checked for a match.

Some embodiments include a method for forming a first cryptographically protected connection of a unit to a device, comprising the following steps from the point of view of the unit:
receiving a connection request from the device, wherein cryptographically protected device connection information and device authentication information is associated with the connection request,
wherein the device connection information indicates which at least one second connection of the device to at least one second device existed at an earlier time,
wherein the device authentication information authenticates the device, and
forming the first cryptographically protected connection of the unit to the device on the basis of the result of a check on the device connection information and the device authentication information,
wherein the cryptographically protected connection of the device to the unit is furthermore formed in particular on the basis of second device connection information,
wherein the first device connection information and the second device connection information is checked for a match.

Some embodiments include a unit for carrying out one or more of the methods as described herein, comprising:
a reception unit designed to receive a connection request from the device, wherein the cryptographically protected device connection information and the device authentication information is associated with the connection request,
wherein the device connection information indicates the at least one second connection of the device to the at least one second device that existed at an earlier time,
wherein the device authentication information authenticates the device, and
a connection unit designed to form the first cryptographically protected connection of the unit to the device on the basis of the result of the check on the device connection information and the device authentication information,
wherein the cryptographically protected connection of the device to the unit is furthermore formed in particular on the basis of second device connection information,
wherein the first device connection information and the second device connection information is checked for a match.

Authorization information that permits a specific access operation by the device, in particular for accessing a unit such as a provisioning server for performing a provisioning process, does not have to be set up explicitly for a specific device. This information may instead be inferred indirectly.

The FIGURE shows a device D for carrying out the various methods incorporating teachings of the present disclosure from the point of view of the device D, and a unit E for carrying out the corresponding method from the point of view of the unit E. The device is shown as an industrial IoT device D (device) having an application runtime environment RTE for executing applications App.

Provision is furthermore made for:
an operating system OS,
a processor CPU,
a first storage unit RAM,
a second storage unit Flash,
an input/output unit I/O for connecting sensors and/or actuators or expansion modules and
a network interface NWIF.

Provision is furthermore made for a power management unit PMU which is connected to an external power supply PS. An external 5G communication modem 5G-M and an AI accelerator AIA (artificial intelligence accelerator), for example a hardware-based inference engine, are connected via I/O interfaces (I/O: input/output).

An app may make a request AR (app request, in particular for provisioning an app configuration or a device configuration) to the app runtime environment RTE via an API interface (API: application programming interface). The app may be present fixedly on the device, for example as part of device firmware, or the app may be an app loaded onto and installed on the device.

The app runtime environment RTE manages information about second devices that were previously connected and/or are currently connected (connected device monitor and ledger CDML). The device connection information regarding connected second devices, which may also be referred to as components, is preferably provided directly by the second device, that is to say the component, for example information about the manufacturer, device type, serial number.

A second device, that is to say a component, is preferably able to authenticate itself cryptographically, as known for example from USB 3.0 or PCIe. It is also possible for a connected component to be identified on the basis of a device fingerprint, that is to say on the basis of an indirect device-specific property (for example analog properties of the device interface that depend on physical properties of electronic interface modules used that result from manufacturing tolerances, for example deviations of resistances, capacitances, inductances from their nominal value).

In some embodiments, the device, that is to say the industrial IoT device D, is able to authenticate itself cryptographically, as known for example from TLS, DTLS, IPsec/IKEv2, MACsec or OPC UA.

This information (optionally filtered and preprocessed) is confirmed in cryptographically protected form CD-Attest by forming the cryptographically protected device connection information, also possibly referred to as connected device attestation information CD-A, which is formed using an attestation key. Furthermore, the device is able to authenticate itself using a device authentication key D-Auth. The two keys may be different; in principle, however, a common key can also be used for device authentication and connected device attestation. This functionality may be implemented using a secure element (for example a crypto controller, a security processor, a trusted platform module), a trusted execution environment or a confidential computing enclave (for example Intel SGX enclave). It is possible to use a common secure element or a common trusted execution environment or a common confidential computing enclave for device authentication and connected device attestation. It is likewise possible to use separate secure elements or separate trusted execution environment or separate confidential computing enclaves for device authentication and connected device attestation. This provides that device authentication and connected device attestation are separated from one another, thus achieving a particularly high level of tamper protection.

The request message Req is transmitted to the unit E, in particular a further device E or a service E. In addition to the actual request AR from the app, it comprises the device authentication information DA and the connected device attestation information CD-A according to the invention that describes which other, second devices were previously connected to the device D to be connected, in particular via a local device interface. The connected device attestation information CD-A and the device authentication information DA is checked CD-A-C, D-C by the device E or service E, to which a connection is intended to be made, and on the basis of this the request Req is processed P-AR (process AR), rejected P-AR or modified P-AR, that is to say processed to a limited extent P-AR, in the request handler RH.

In some embodiments, the request Req comprises the three elements of: request AR from the app, device authentication information DA and connected device attestation information CD-A. However, it is also possible for these three elements to be referenced, for example by means of a URI or a cryptographic identifier, in particular a cryptographic hash value of the respective element. In particular, the connected device attestation information CD-A according to the invention can also be transmitted or provided separately, with the result that it can be associated with a request Req, in particular by including a reference to the connected device attestation information CD-A in the request message.

The device authentication information DA may also be app-specific device authentication information. The device D can therefore use different device authentication keys for different apps, for example. Depending on the app from which a request AR originates, a device authentication key associated with the respective app is selected or determined and used to form the device authentication information.

The device authentication information DA for the request message may be a digital signature. The digital signature may protect the request message that comprises the request AR and the attestation or the attestation reference. It is likewise possible for the device authentication information and the attestation or the attestation reference to be used during an authentication and key agreement in order to set up a cryptographically protected, authenticated transmission channel that is used to transmit the request AR.

The request may in particular relate to:
registration of the device in a device database (as a permissible device)
issuing of a credential (digital certificate, security token) for the requesting device
generation and provision of a cryptographic key for the requesting device
formation of a blockchain transaction (distributed ledger, distributed database) by an accessing blockchain oracle (that is to say the accessing device implements a blockchain client/blockchain wallet)
setup of a network access connection (for example PDP context or PDU session of a mobile radio system) to a network infrastructure (network access control, 3GPP 5G primary authentication)
request for a network access connection (for example PDP context or PDU session of a mobile radio system) for accessing a slice of the network infrastructure (for example 3GPP 5G secondary authentication)
request for an app download, firmware update
provision of or request for a sensor measured value that records a physical variable of a technical system (for example temperature, force, pressure, speed of movement, flow speed, flow rate, rotational speed, torque)
provision of or request for a control command for controlling an actuator in order to influence a technical system (for example a machine tool, drive, heating element)
provision of or request for recipe data or planning data for the configuration of a controller, a machine or an installation.

Although the teachings herein have been described and illustrated more specifically in detail by means of the exemplary embodiments, the scope of the disclosure is not restricted by the disclosed examples and other variations can be derived therefrom by a person skilled in the art without departing from the scope of protection thereof.

What is claimed is:

1. A method for forming a first cryptographically protected connection of a device to a unit, the method comprising:
transmitting a connection request from the device, wherein the connection request includes associated cryptographically protected device connection information and device authentication information,
wherein the device connection information indicates a second connection of the device to a second device existed at an earlier time,
wherein the device authentication information authenticates the device;
checking the first device connection information and a second device connection information for first match;
checking the device connection information and the device authentication information for a second match; and
forming the first cryptographically protected connection of the device to the unit based on
the first match and the second match.

2. The method as claimed in claim 1, wherein the device connection information indicates a second device with which the a connection currently exists.

3. The method as claimed in claim 1, wherein the device connection information includes:
an identifier of a device manufacturer, device type, and/or device serial number; and/or
an authentication credential including a certificate, a cryptographic key, and/or a password hash of the second device with which the second connection existed.

4. The method as claimed in claim 1, wherein the connection request further includes:
the time at which,
the duration for which,
the device interface via which, and/or
a third connection in combination with which the second connection existed.

5. The method as claimed in claim 1, wherein the device connection information is provided by:
the device and/or
an external unit.

6. The method as claimed in claim 1, wherein the second device includes:
a peripheral device,
an expansion module,
a tool of a machine tool, and/or
an IoT device.

7. The method as claimed in claim 1, wherein the unit includes:
a server,
a cloud service,
an edge device,
a controller,
a control function,
a third device,
a communication network,
an onboarding network,
a provisioning server, and/or
a device management server.

8. The method as claimed in claim 1,
wherein checking the connection request includes applying rules to decide:
to give permission,
to give limited permission, or
to form the first cryptographically protected connection of the device to the unit.

9. The method as claimed in claim 1, wherein:
the connection request is transmitted to the unit, and/or
the unit check the device connection information and/or the device authentication information.

10. The method as claimed in claim 1, wherein the device authentication information includes a device fingerprint of the device.

11. The method as claimed in claim 1, wherein the device authentication information is cryptographically protected.

12. A device comprising:
a transmission unit to transmit a connection request including cryptographically protected device connection information and device authentication information;
wherein the device connection information indicates a second connection of the device to a second device that existed at an earlier time;
wherein the device authentication information authenticates the device; and
a connection unit to form a first cryptographically protected connection of the device to a unit based on a result of a check on the device connection information against the device authentication information and first device connection information against second device connection information.

13. A method for forming a first cryptographically protected connection of a unit to a device, the method comprising:
receiving a connection request from the device, the connection request including
cryptographically protected device connection information and device authentication information,
wherein the device connection information indicates a second connection of the device to a second device existed at an earlier time and
the device authentication information (DA) authenticates the device;
checking the device connection information and the device authentication information;
checking the first device connection information against the second device connection information; and
forming the first cryptographically protected connection of the unit to the device on the basis the checks.

14. (canceled)
